(19) United States
(12) Patent Application Publication
(10) Pub. No.: US 2009/0306978 A1
(43) Pub. Date: Dec. 10, 2009

(54) METHOD AND SYSTEM FOR ENCODING LANGUAGES

(75) Inventor: Robert Andrew McMahon McNeilly, Benowa (AU)

Correspondence Address: DENNISON, SCHULTZ & MACDONALD, 1727 KING STREET, SUITE 105, ALEXANDRIA, VA, 22314, US

(73) Assignee: LISTED VENTURES PTY LTD, Auckland (NZ)

(21) Appl. No.: 12/092,321

(22) PCT Filed: Nov. 2, 2006
(86) PCT No.: PCT/AU06/01639

§ 371 Date: Jul. 15, 2008

(30) Foreign Application Priority Data
Nov. 2, 2005 (AU) 2005906056
Nov. 7, 2005 (US) 60734325

(51) Int. Cl. G10L 21/06

(52) U.S. Cl. 704/230; 704/E21.019

(57) ABSTRACT

A method of encoding and decoding languages for international communication. A set of core words may be encoded, although the full vocabulary of the language might also be covered. The result is particularly suitable for use by people in relation to the keypad of a mobile phone, but may also be implemented in translation or communication software to create a language database for example. The encoding includes assigning digital symbols to selected words in the language, assigning alphanumeric representations to the digital symbols, and assigning pronounceable elements to the alphanumeric representations.

### FIELD OF THE INVENTION

This invention relates to methods and systems for encoding languages using the alphanumeric pattern found on a telephone keypad, in particular but not only to a method of encoding and decoding English. The coding principles can provide a relatively simple communication system and method which may be used by people who would ordinarily be unable to communicate. Encoded languages are also considered suitable for text messaging and voice recognition and for use in software processes.

### BACKGROUND TO THE INVENTION

In the last one hundred years mankind has achieved access to rapid forms of communication. People can now almost instantaneously access communication systems around the globe. Yet for all this access and increased communicating speed our true ability to communicate effectively has risen relatively slowly due to the inherent barriers in languages. Our current languages are barely capable of interfacing with our current and future digital technologies. There has long been a need for easier access to and use of digitalized information.

Any movement to universality of language is still a foot race with English out in front but still not the end winner because of its endless rules and inherent complexities. Additionally, English is probably the most difficult language to learn and to fully integrate with digital technologies. Current languages were born in different eras and it is if we are hauling our horse and buggy into the family car before setting off on a drive. These old languages are now failing badly and are out of step with our communication needs. Technology now requires a Digital based communication system. Universality requires ease of learning and use.

### SUMMARY OF THE INVENTION

It is an object of the invention to provide for improved communication between people and/or between people and computers, or at least to provide an alternative to existing methods of communication.

In one aspect the invention resides in a method of encoding language data in a computer system, including: receiving input of language data in a text format, selecting words in the text for conversion into a coded format, assigning digital symbols to the selected words, assigning alphanumeric representations to the digital symbols, assigning pronounceable elements to the alphanumeric representations, and generating an output containing the pronounceable elements.

In another aspect the invention resides in a method of encoding a language for international communication, including: assigning digital symbols to selected words in a source language, assigning alphanumeric representations to the digital symbols, and assigning pronounceable elements to the alphanumeric representations.

In general, a digital Symbol Number is assigned to each Source Language “Word”, then this Symbol Number is then additionally assigned to similar meaning corresponding symbols (Words) in multiple alternative languages thus creating the Universal Digital Symbol for that (“Meaning Symbol Word”) across many languages. The selected symbols include a set of core symbols required for relatively simple communication in the Code. Typically about 900 symbols may be in this set.

In a full version, the selected symbols include a set of substantially all symbols required for communication. The currently encoded source language is English, although application to other source languages is also envisaged. By using a matrix based communication Code most or all language exception rules can be eliminated from communication. Spelling, grammar and other historical language functions are reduced to a knowable pattern.

In one embodiment each numerical Code includes one or more numbered pairs determined by a two dimensional matrix (1, 2, 3, 4, 5, 6, 7, 8, 9, 0)×(1, 2, 3, 4, 5, 6, 7, 8, 9, 0). Various other matrix representations may be implemented. Most or all of the alphanumeric representations are derived from the numerical Codes according to the keypad of a mobile phone.

The 100 Alphanumeric representations include 26 Alphabet Letters, 46 First Letter-Number Combinations, and 28 Number-Number Combinations.

The numerical Code for each of the 26 Alphabet Letter items is determined by combining a first digit indicating location of the item on a key of the keypad, with a second digit indicating location of the item in relation to other items on the key.

The numerical Code for each of the 46 First Letter-Number Combinations is determined by substituting the Number (2, 3, 4, 5, 6, 7, 8, 9) with the appropriate first alphabet item from the corresponding key on the keypad and adding one of 4, 5, 6, 7, 8 or 9 after the first number.

The numerical Code for each of the 28 Number-Number Combinations is determined by the relevant two numbered pair on the Matrix.

The pronounceable elements are derived from small sounds assigned to each of the digits (1, 2, 3, 4, 5, 6, 7, 8, 9, 0).

The invention also resides in an electronic communication system or dictionary system that encodes and/or decodes symbols of a language and alternative linked languages as defined above.

The invention may also be said to reside in any alternative combination of features that are indicated in this specification. All equivalents of these features are included whether or not explicitly set out.

### LIST OF FIGURES

Preferred embodiments of the invention will be described with respect to the accompanying drawings, of which:

FIG. 1 shows the 26 letter of the Alphabet as used on the Telephone Keypad,

FIG. 2 shows the Letter-Number layout of a typical telephone keypad,

FIG. 3 shows the “10 by 10” Digital Matrix found on the Telephone Keypad,

FIG. 4 shows the Digital Matrix Interchanger,

FIG. 5 shows the Matrix Interchanger Cross Section,

FIG. 6 shows the 26 Alphabet Letters Code Bits,

FIG. 7 shows the 46 First Letters-Number Code Bits,

FIG. 8 shows the 28 Number-Number Code Bits,

FIG. 9 shows the 10 pronunciations changes to the Numbers and 6 changed Letter pronunciations,

FIG. 10 shows an Example of Cross Section “J” of the Slang Matrix Interchanger,

FIG. 11 shows the Spoken Slang Matrix Interchanger,

FIG. 12 shows the 100 Code Bits,

FIG. 13 shows 100 Data Entry Keyboard,

FIG. 14 show an Example Conversation between two people,

FIG. 15 shows Grammar Protocol,

FIG. 16 shows the Core Communication Symbols,

FIG. 17 shows how a Language is encoded,

FIG. 18 shows Universal Communication,

FIG. 19 shows Translation of English text to an alternative language with Display and output in the Alternative Language,

FIG. 20 shows 10 Digital Communication,

FIG. 21 shows the steps to Convert Text into Code

FIG. 22 shows Voice Recognition

FIG. 23 shows 10 Digital Handheld Data Entry Keypad

FIG. 24 shows how the Code Searches Existing Data Bases

FIG. 25 shows the Code used and displayed in Games

FIG. 26 shows the Code used and displayed on the Internet

FIG. 27 show Code being used for Handheld Messaging

### DESCRIPTION OF THE PREFERRED EMBODIMENTS

Referring to the drawings it will be appreciated that the encoding method and database software invention can be implemented in a variety of ways in the context of modern communications technology.

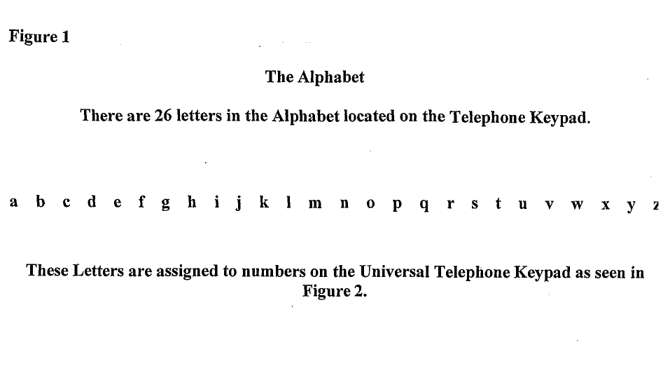

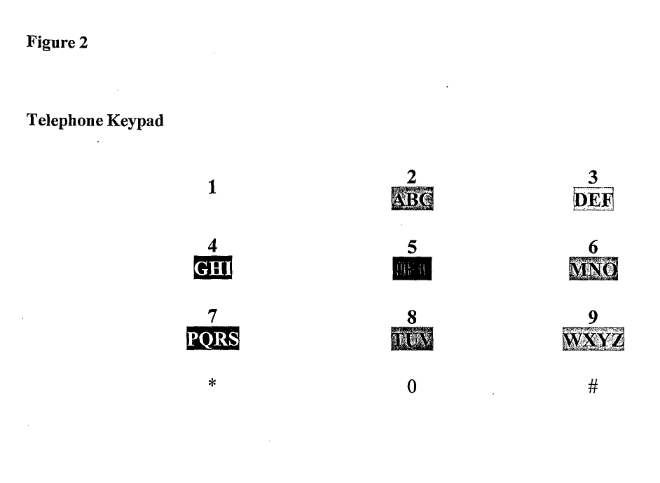

Technology now requires a numerical based communication system. Universality requires easy of learning and use. A Communication Code based on the typical telephone keypad, as shown in FIGS. 1 and 2, can provide an advantage because of its widespread use and familiarity for many people around the world. Using a Two Number Pair Matrix creates the needed paradigm shift of communication's interaction with technology.

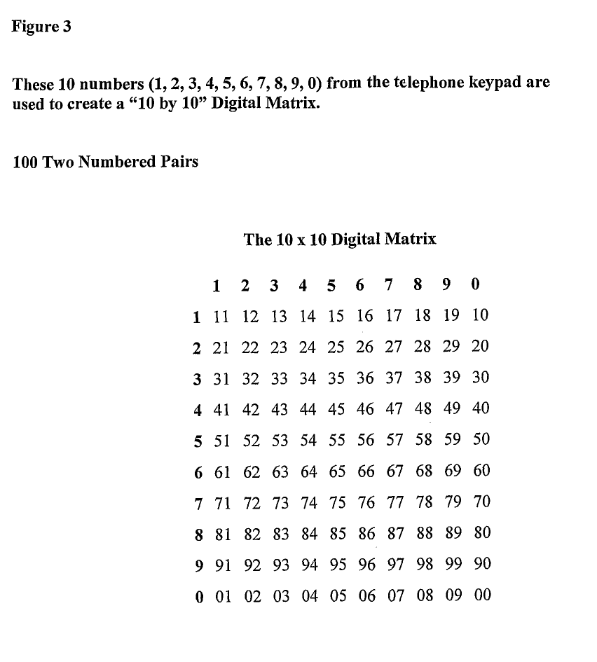

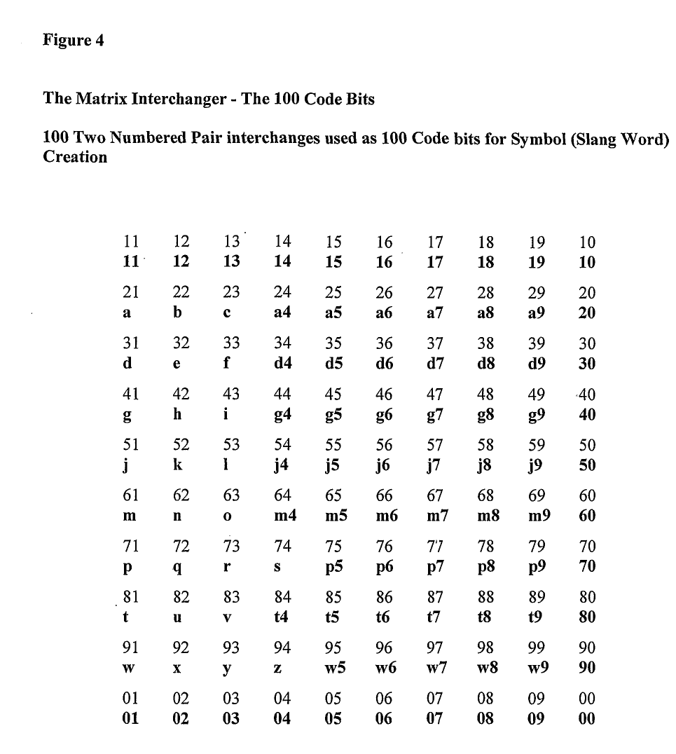

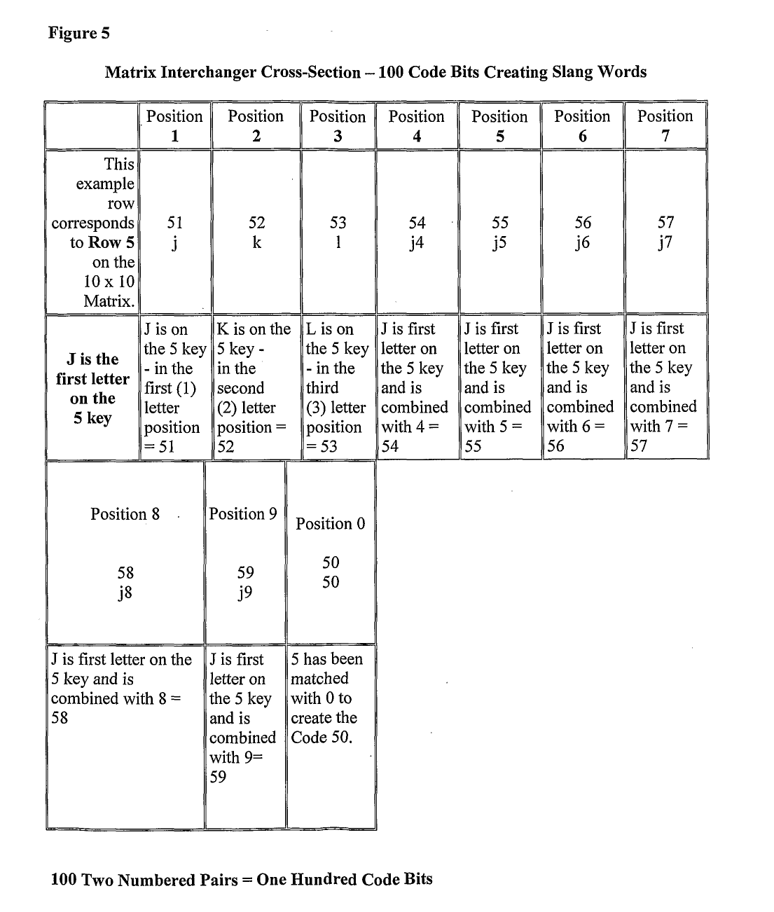

In the Code Matrix, such as shown in FIG. 3, the Two Number Pair is the smallest part of the Code. Using only the numbers, 1, 2, 3, 4, 5, 6, 7, 8, 9, and 0 in this example, the Code sets up a Matrix of 100 possibilities—10 spaces down and 10 spaces across. Each of the 100 spaces is assigned its respective Two Number Pair in the grid. Put into sequences, the Two Number Pair allows for endless new numbers to be created. Using this repeating Two Number Pair pattern allows a Universal Symbol Number to be assigned to every Symbol in the various languages created by mankind. It is the assigning of similar Symbol Number into each language that enables the Code to provide Communicational Universality. All languages have common Symbols. Example Symbols like, door, leg, boy, sunlight, and run can be found in all languages. Each common Symbol in any language is assigned the same Symbol Number in the database.

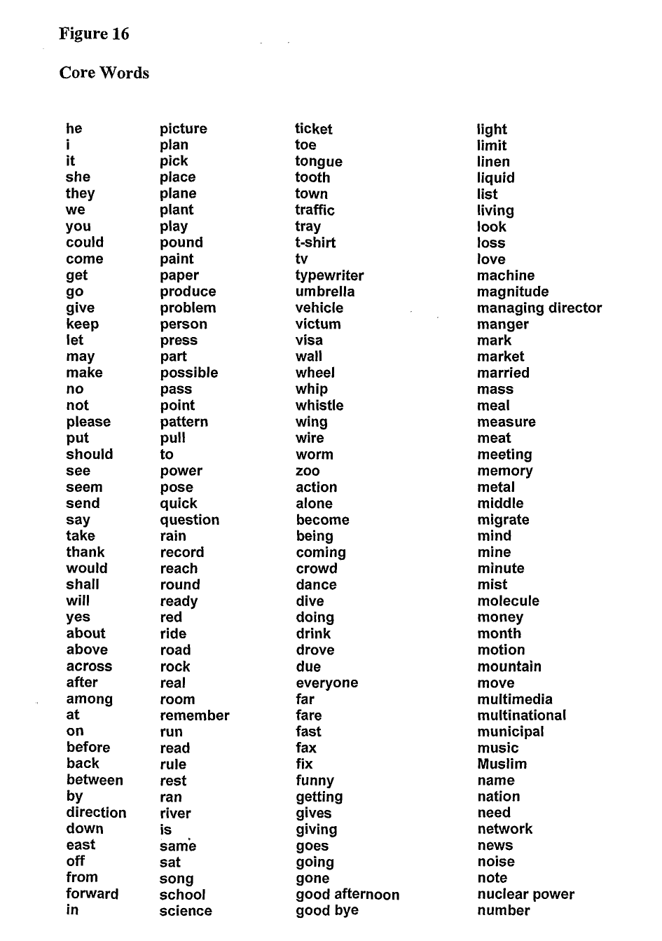

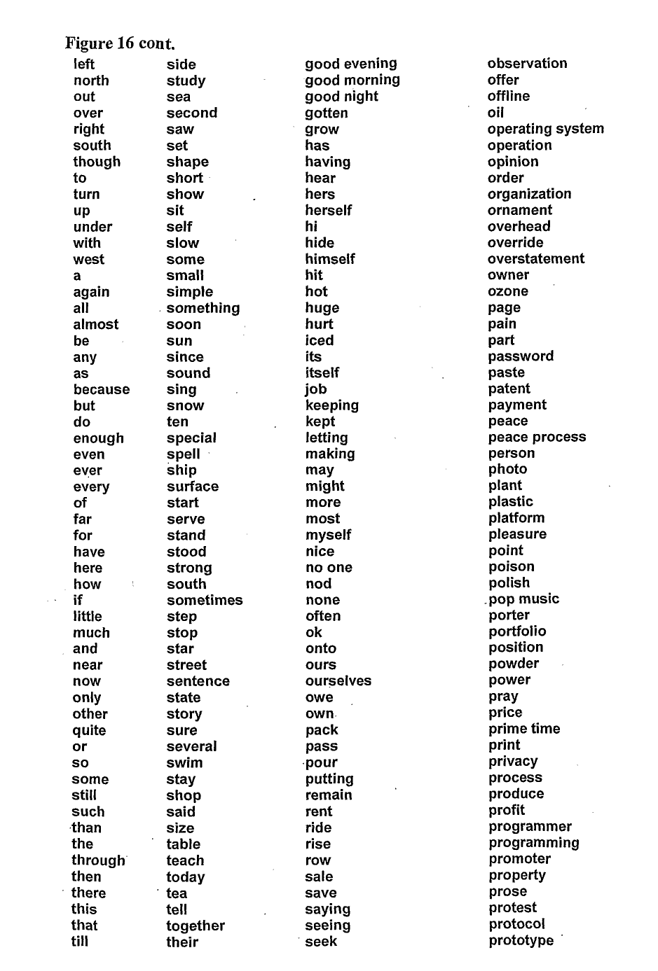

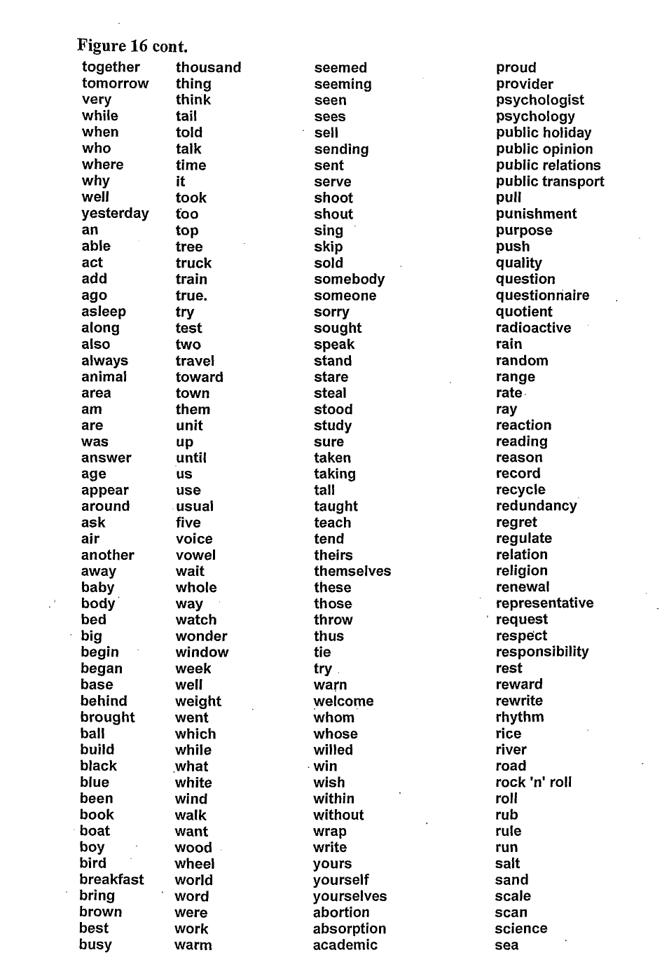

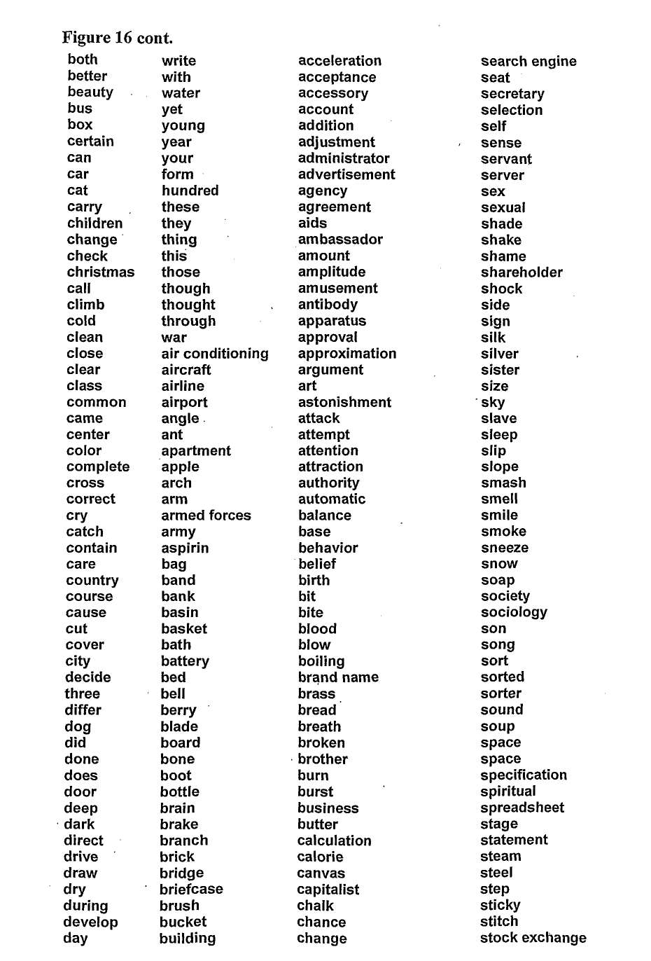

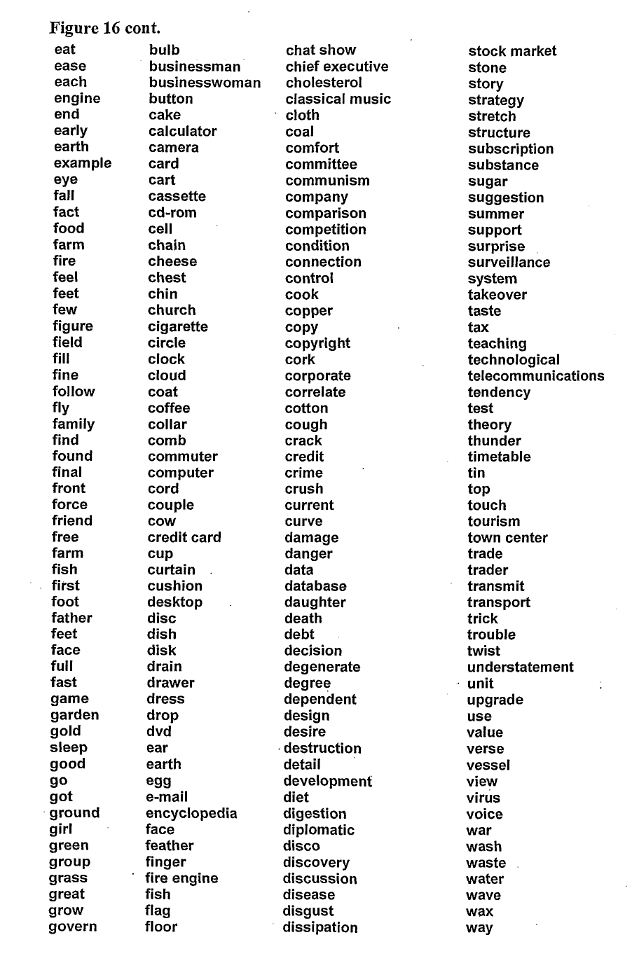

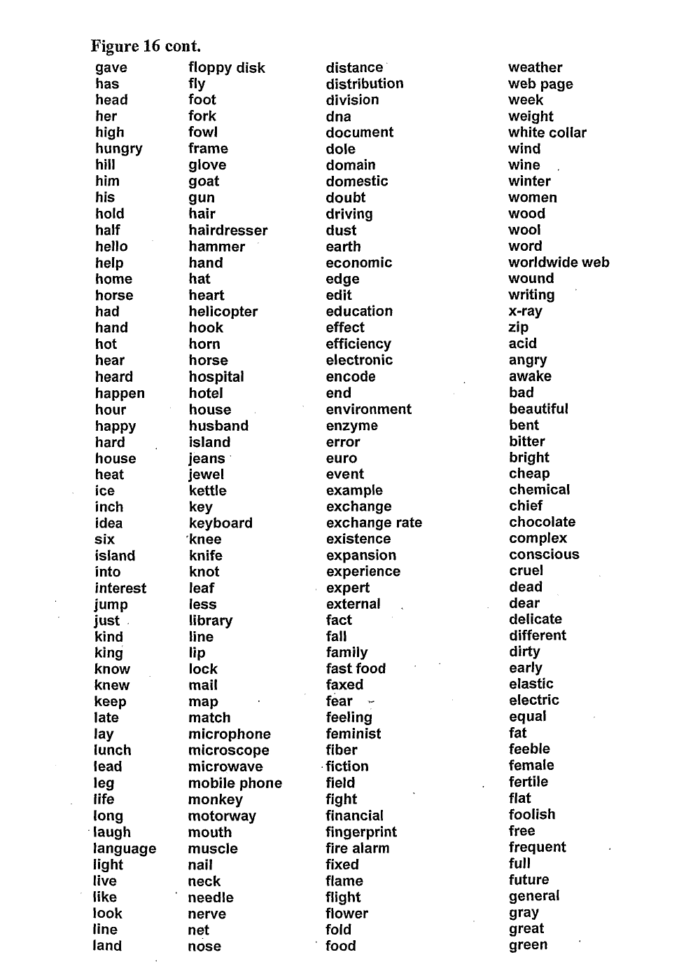

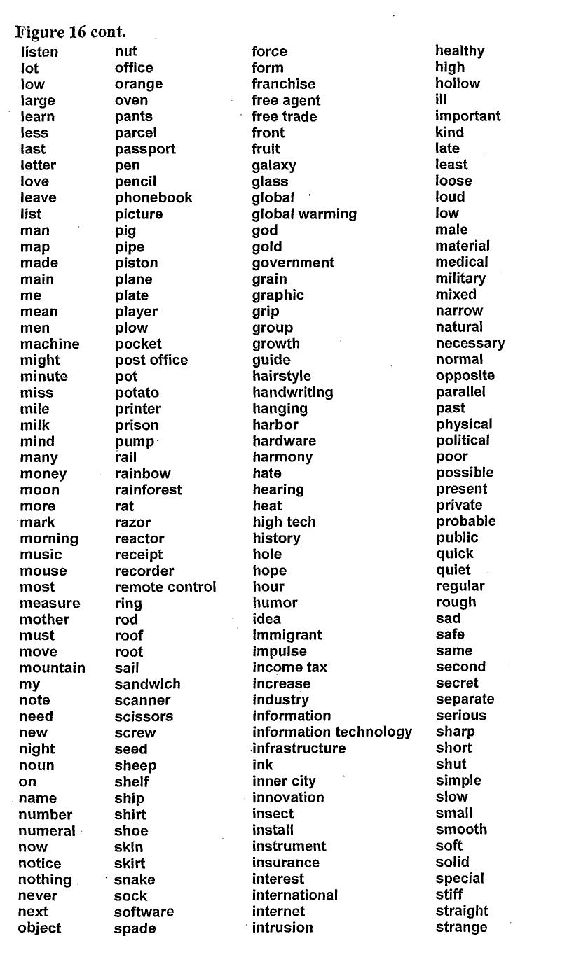

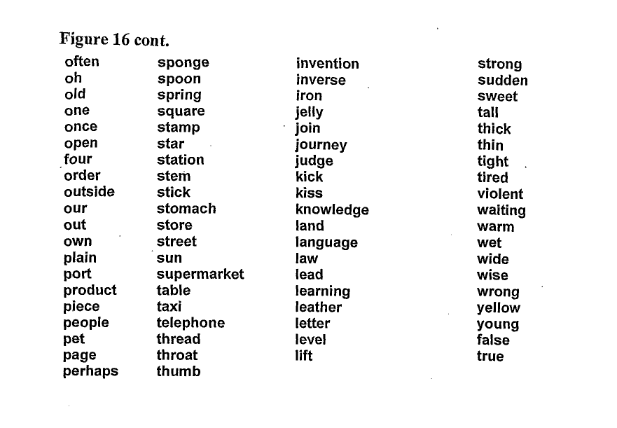

To make fluency relatively easy all Common Symbols have been identified in the Code. Additionally, these Common Symbols have then been separated in two groups. The smallest group is typically reduced to about 900 Symbols and is called The Core Symbols. These Core Symbols thus allows a person to be fully fluent by learning about 900 basic Symbols, such as shown for the English language in FIG. 16. These Symbols may fit onto a few typewritten pages. The average speaker does not use many Symbols in his everyday conversations so the Code has identified the best 900 language Symbols to learn first in order to be able to communicate effectively. This makes commencing to learn and use of the Code relatively simple. The user can typically begin communicating using about 100 Symbols of The Core Symbols.

Symbols particular to each language but not universally found in many languages are also assigned a Symbol Numbers. The result is that any Symbol “Common or Uncommon” in any language can be assigned a unique Symbol Number. The Symbol Numbers are created from the Two Number Pair followed by a Two Number Pair from the 100×100 possibilities available. This sequence of repeating Two Number Pairs is the underlying bases that allows the Code to be a Digital Communication Code. The repeating of 100×100×100×100 is continued as many times as necessary.

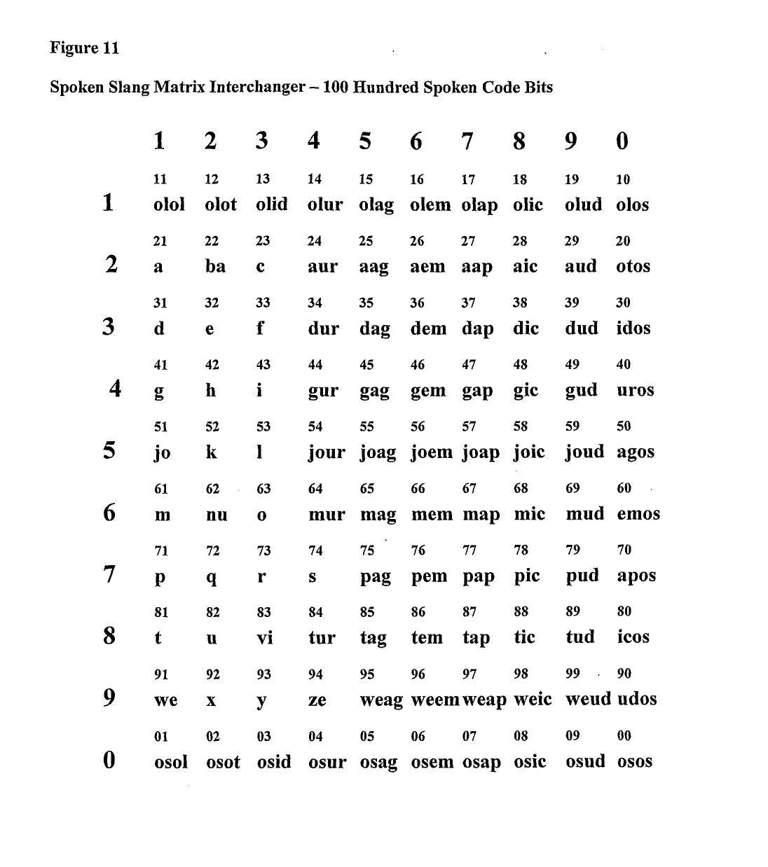

The creation of Universal Slang Symbols from the distinct sequential Two Number Pairs allows the Matrix to be verbally communicated. Slang is created from underlying Symbol parts assigned in the pattern to each of the 100 unique Two Number Pairs. The method creates unlimited new unique Slang Symbols. The Slang Symbol creation pattern is easily learned. FIG. 11

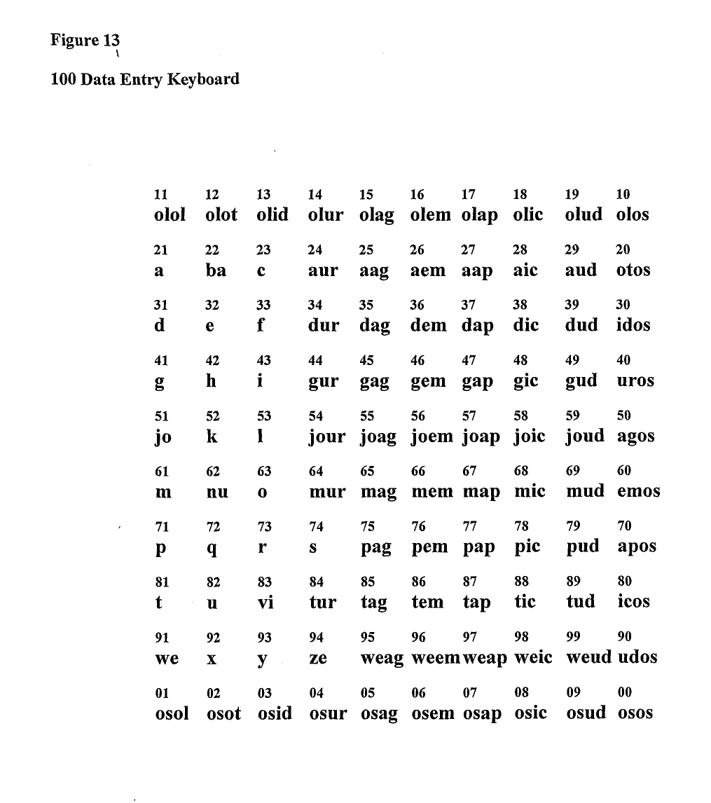

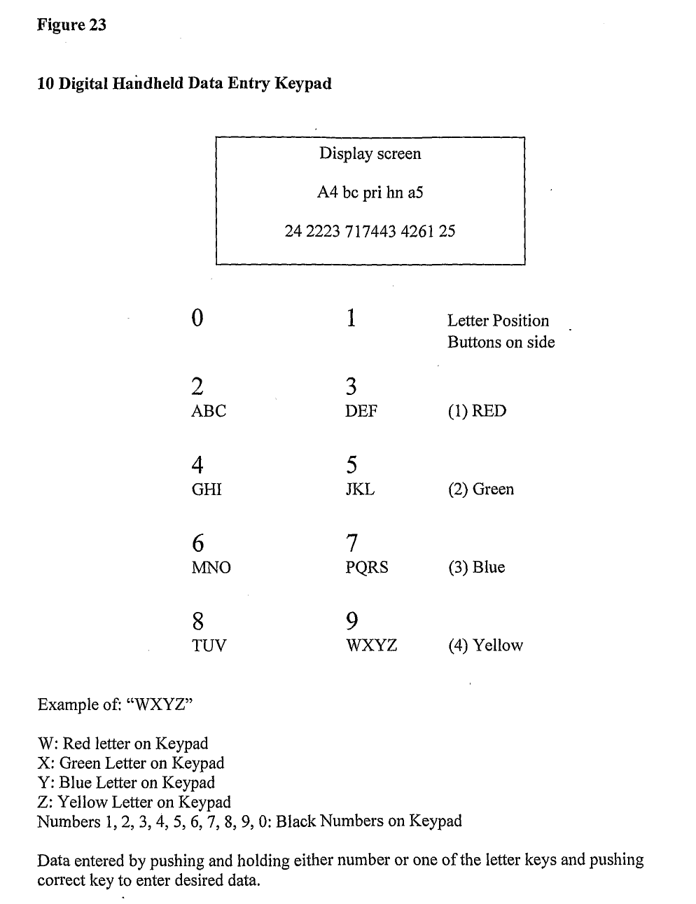

It is difficult to learn, use and remember Symbols if they are only numbers. Therefore each Symbol's number is hidden in the Slang Symbol's formation which can be retrieved by the underlying Matrix. This is especially useful when communicating with voice recognition technology, giving machine commands or simply not having to physically enter a text messages in order to send a text message. The Code additionally eliminates the current Keyboard's need to learn to type and replaces it with a ten number entry system FIGS. 2 and 23 or a 100 Matrix Keyboard as shown in FIG. 13.

Using the Matrix a Symbol's number can therefore be extracted for use when needed. Once familiar and used for a short length of time, a user can use the Matrix to change over from, Digital to Slang or Slang to Digital.

The Code can additionally be spoken or communicated in pure digital form and this is useful if a disability is present or an accent or speech impediment is a problem. The digital part of the matrix typically requires the user to learn and use about 10 distinct sounds to fully communicate. Additionally, if the person wishes to hand signal while speaking to reinforce what he is trying to communicate this can be helpful where understanding is a problem. Being a digital Code it will allow the disabled to communicate if they can make one slight movement or noise. Additionally, the Code can be signed, signalled, communicated by position, pressure, volume, speed, heat, touch, movement, light, on-off, sound and it can be written or spoken. People can easily verbally communicate by using the Code's reduced vocabulary method of communicating. The Code's ease of learning, limited number of Symbols required to be fluent and its universality, allow for the elimination of most communications barriers between peoples of different cultures and languages. It can be learned without any verbal instructions by using just numbers and pictures only.

Understanding the underlying numeric part of the Code is only the first step in creating a Code that is digital, but is also capable of creating endless unique Symbols. Each of the 100 Two Number Pairs of the Code is assigned a separate and unique distinct sound. Therefore the Code has 100 unique sounds.

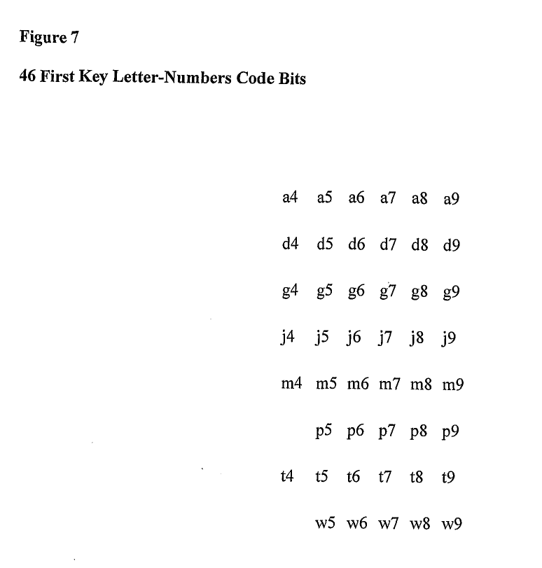

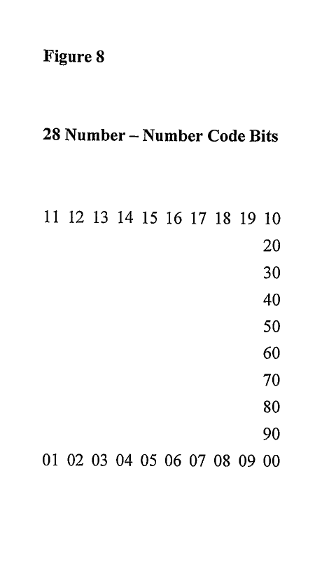

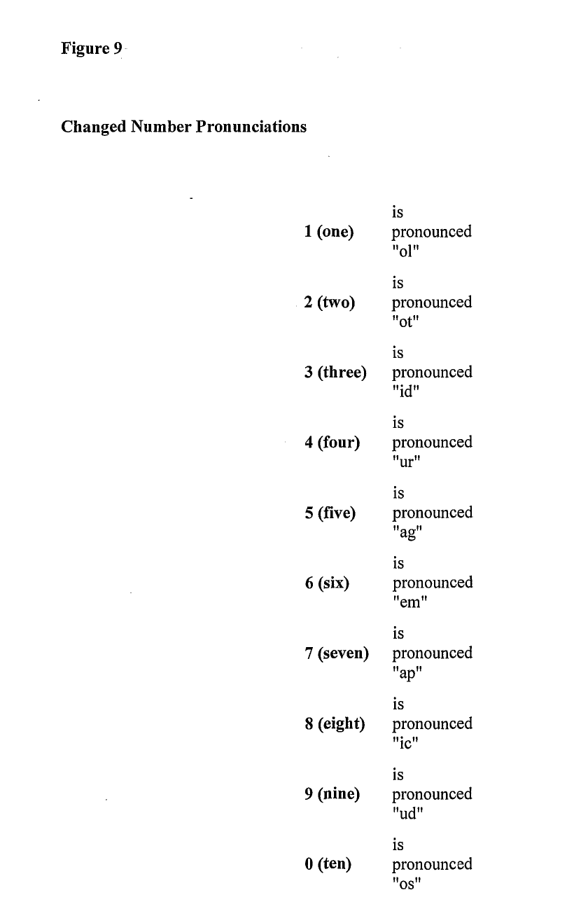

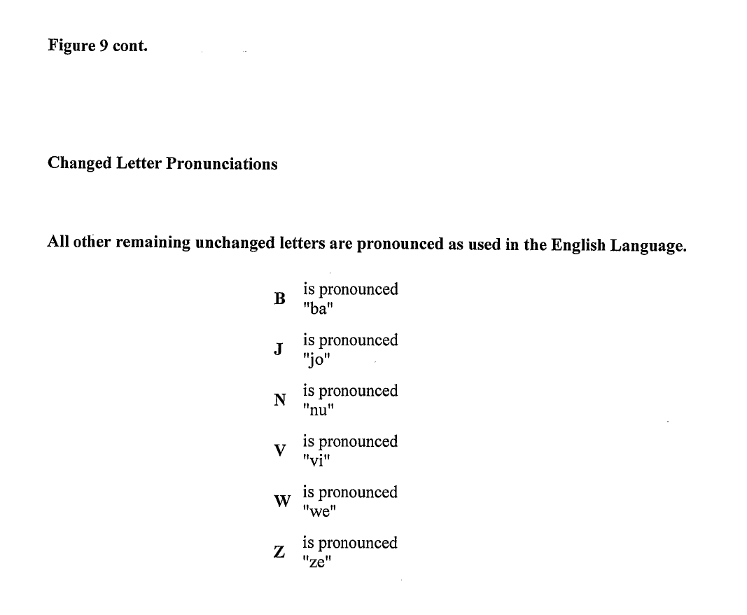

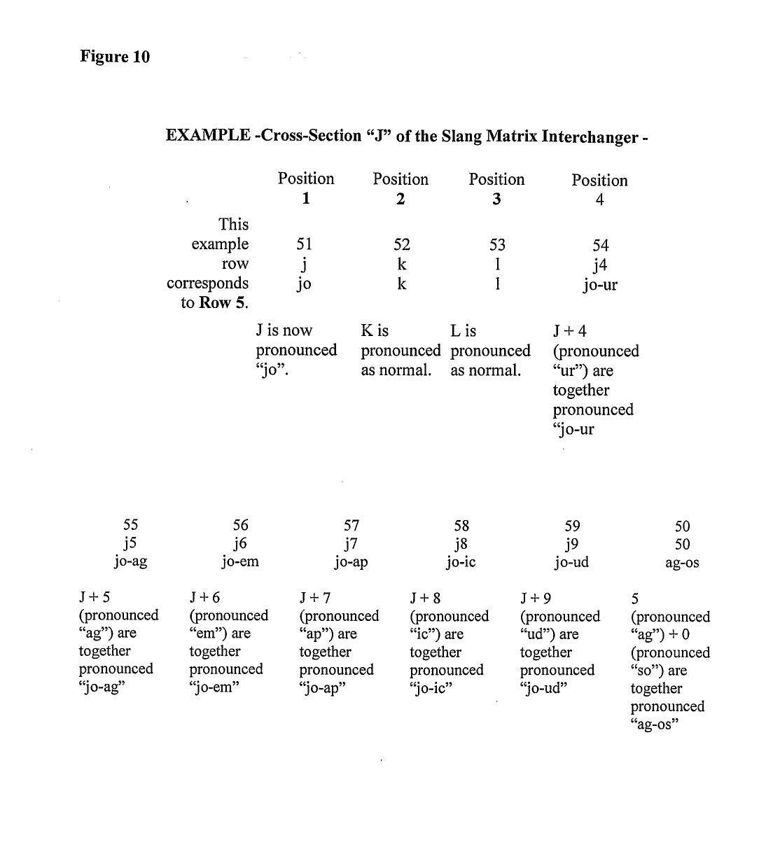

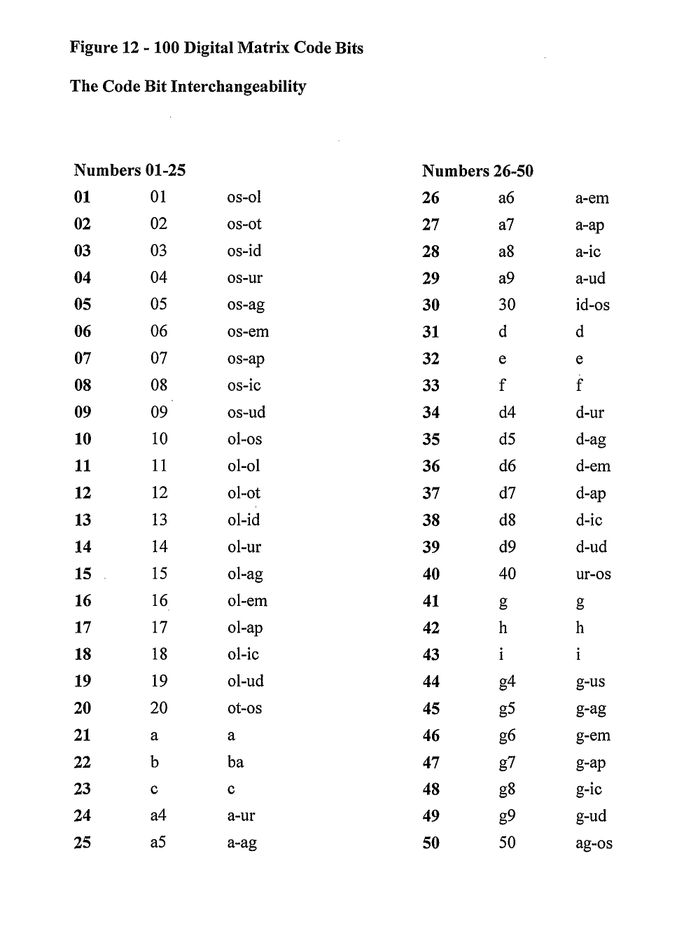

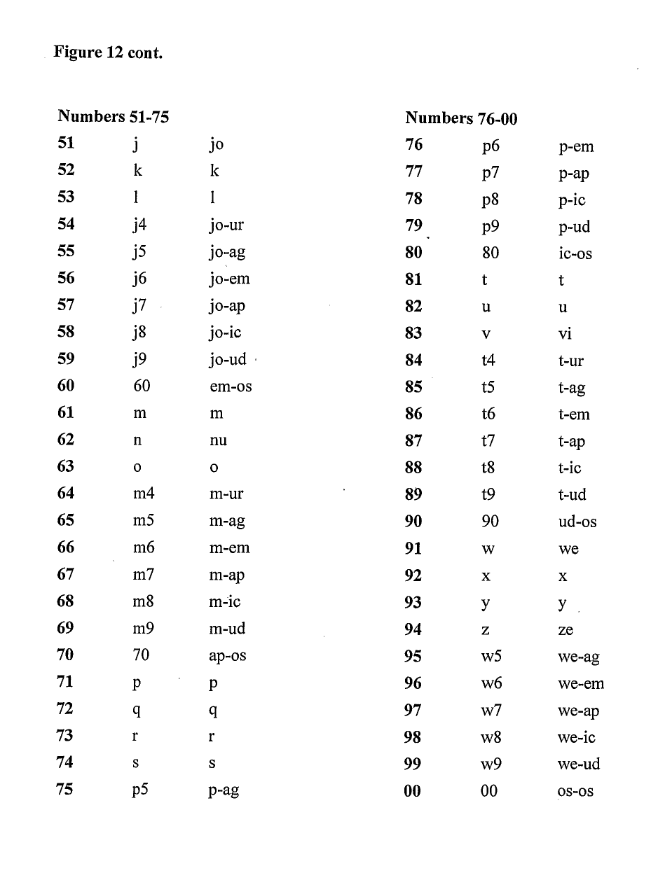

These distinct sounds are used to create Slang Symbols. These small sound parts (syllables) are then used in different combinations to create Symbols (“Words”) similar to what happens in all languages. In the Code the syllables are created out of a separate Letter from the 26 Letters (a, b, c, d, e, f, g, h, i, j, k, l, m, n, o, p, q, r, s, t, u, v, w, x, y, z) in the Latin alphabet, as shown in FIGS. 1 and 12. Additionally, there are 46 first letter-number syllables created from two part combinations—8 First Keypad Letters (a, d, g, j, m, p, t, w) from the alphabet and the 6 numbers (4 to 9), as shown in FIGS. 7 and 12. The 28 Number-Number syllables are created from the two number pair assigned to that part of the Matrix. FIGS. 8 and 12.

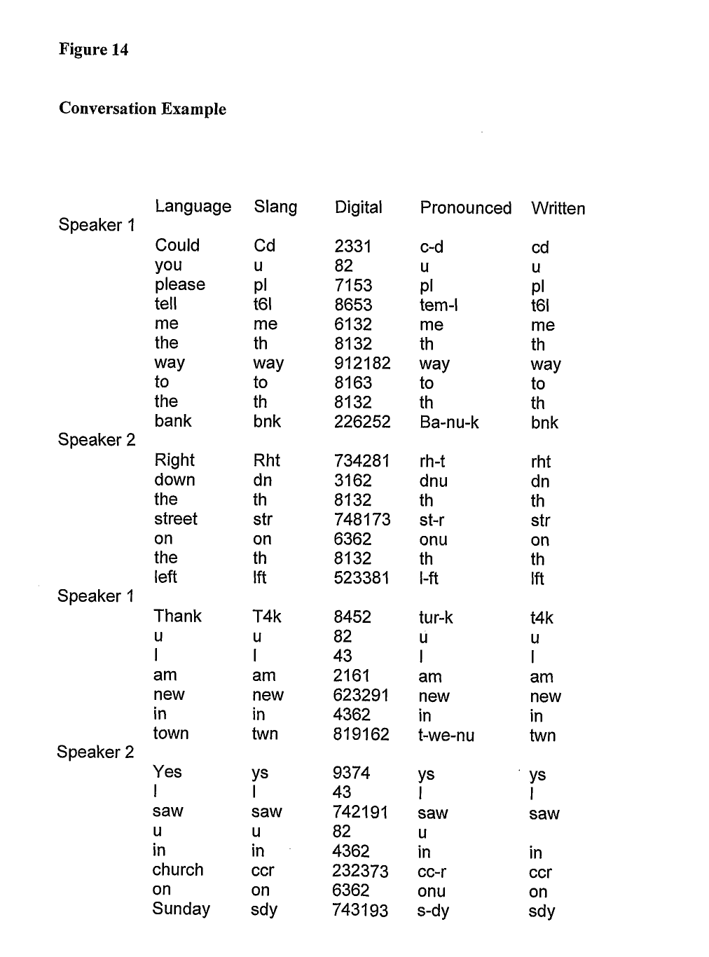

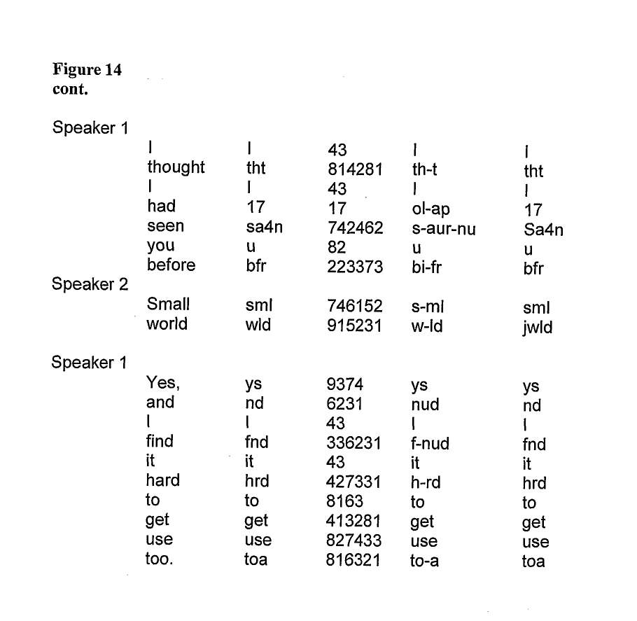

The above method of Slang creation creates unique Symbols all of which have abbreviated length. FIG. 14.

The 26 Letters follow the pattern based on the Key's number and each Letter's locations on each respective Key of the modern phone. The Latin alphabet was chosen because it is the alphabet in use on the modern telephone and therefore most commonly recognized through out the world. FIGS. 1 and 2

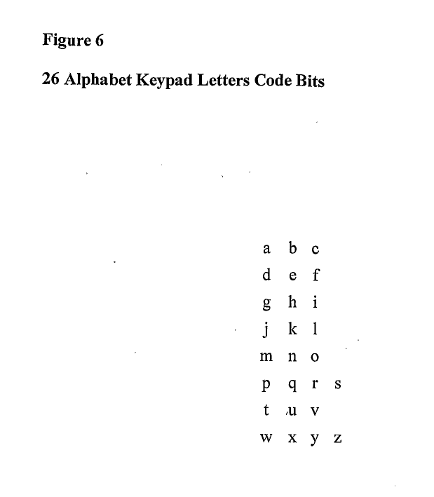

If the combination is an Letter Combination as in FIG. 6, this signifies that the number on the Matrix is created using the first number (which is the Key's number) and one of the 1, 2, 3 or 4 Letters position that specific alphabetic Letter has on that Key. Any alphabet Letter used is always located on the numbered Key chosen and is either the first, second, third or fourth Letter on that Key. Only two numbered Keys—7 and 9—have four Letters, all the rest have only three. The “0” and “1” Keys have no letters.

“A” is “21” because “a” is located on the “2” key—therefore the first number is “2” and the “a” is the first Letter position on the 2 key—so the second number is 1. The pattern repeats exactly the same for all The Alphabet Letter Combinations. Find the Letter's Key number, —which is the first number, —then locate which position that the Letter is used on that Key—which gives the second number (1, 2, 3, 4,) to create any Letter Combination Two Number Pair. So in our example “g” is 41 because “g’ is located on the fourth key and “g” is on the first position of the 4^{th} Key. “r” is therefore 73. “z” is 94.

The remaining part of the Code consists of The 46 First Letter Number Combinations as shown in FIGS. 7 and 12. The First number is created from the position of the First Letter on each numbered (2 to 9) Key (a, d, g, j, m, p, t, w,)—which digitally are Keys—2, 3, 4, 5, 6, 7, 8, 9,). The Second number of The Non Alphabet Combination Two Number Pair is simply the number (4 to 9) on the numbered Key used to create the second number in this number pair.

The Remaining part of the Code consists of 28 Number-Number combinations and these are created by using any two number pair in combination with either a “1” or a “0”. These number-number combinations are used for grammar commands and coding commands. FIGS. 8 and 12.

The Code reduces or eliminates the last three most difficult language barriers—universality, easy of learning and digital technological interfacing. Language problems are reduced by substituting this basic Matrix Code for Symbol creation. Then learning the most important Symbols needed first, and then finally, reducing all grammar to an extreme basic protocol and finally eliminating spelling mistakes because the underlying pattern is always the same. The Code eliminates most language rules because they no longer serve any purpose and make learning very difficult. These changes make learning the Code relatively simple, and because there are no rules, mistakes by the user are less likely. The Code and its Matrix is not a language. It assigns every Common and Uncommon Symbol in any language in the world with its own unique Symbol Number. Then using its simple Matrix these universal Symbol Numbers are converted into a universal verbal Slang. For example “12” in slang is “olot” and it is pronounced “ol”-“ot”. The full Slang Matrix is indicated by FIGS. 11 and 12.

FIG. 14 shows a conversational example of how a language is encoded and used for an everyday communication between speakers, one or neither of whom may be fluent in English. In this example, the English Symbols listed in the “language” column have been assigned arbitrary Two Number Pairs, as listed in the “digital” column. These may be represented alphanumerically as listed in the “written” column. They may further be converted in to slang as listed in the “slang” column, and spoken as listed in the “pronounced” column. The full prototype version the Code has yet to be finalized for the English source language, and it will be appreciated that the full completed version may be encoded differently to this example.

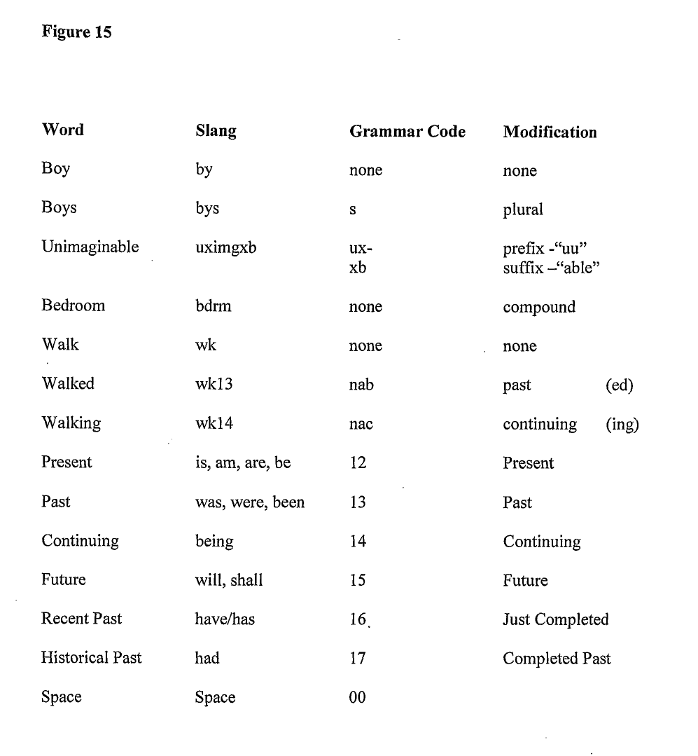

FIG. 15 shows the coding of the grammar protocol to show tenses, plural and other necessary grammar commands.

FIG. 16 shows the Core Words which are learned first and allow easy universal communication. The user of the Code learns the most need symbols first and most communication between people can take place effectively with about 850 words.

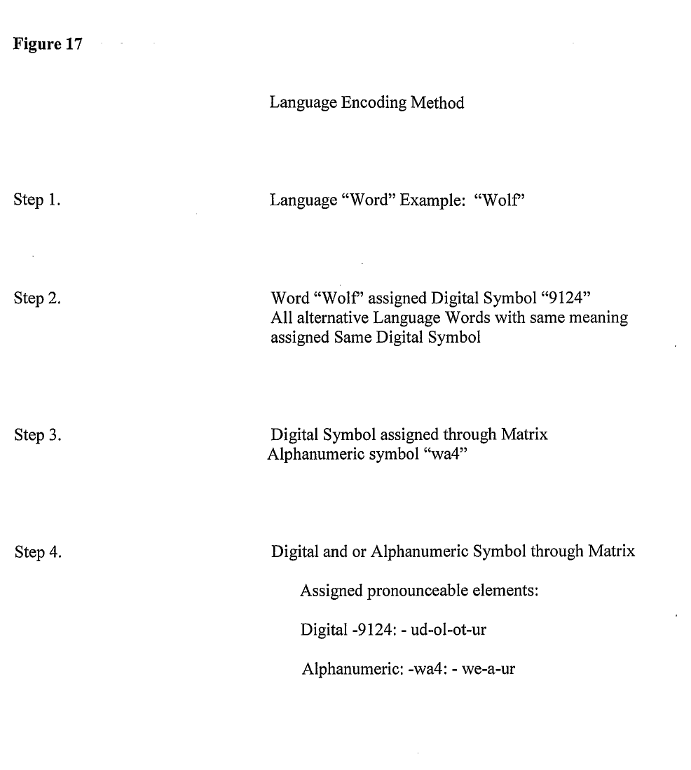

FIG. 17 shows The method of how languages are encoded in Digital and Slang. Any word in any language can be assigned a symbol number and by using the matrix that symbol Number can be converted into Slang. Since the words can be encoded into a digital format communication can take place using methods not available using historic languages.

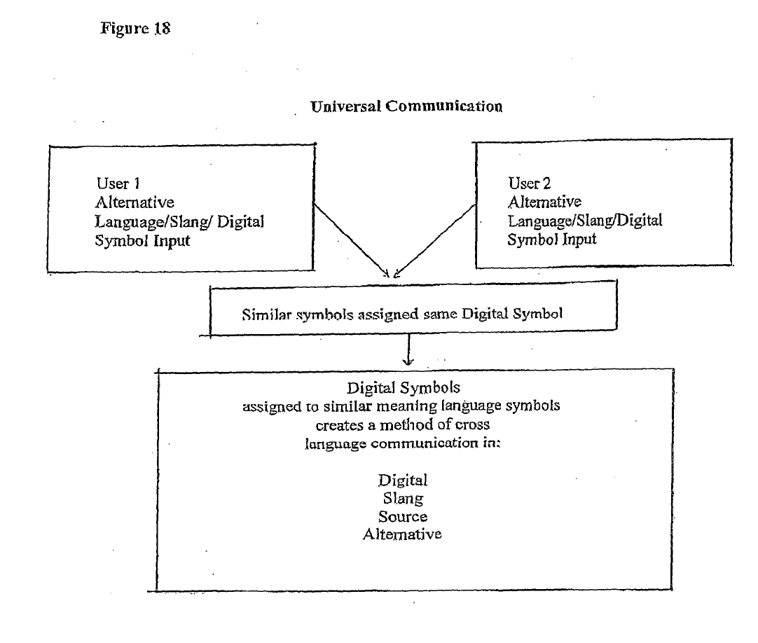

FIG. 18 shows how Universal communication can take place by assigning a Universal Digital Symbol. The Database allows for alternate language communication by the assignment of the same Number Symbol to same meaning words in alternative languages.

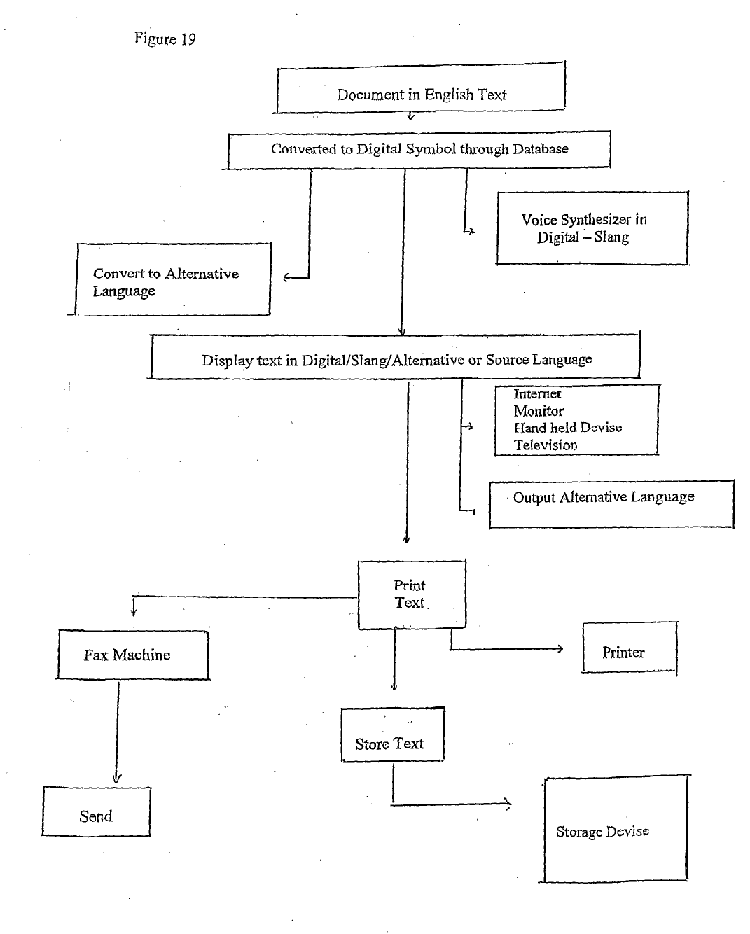

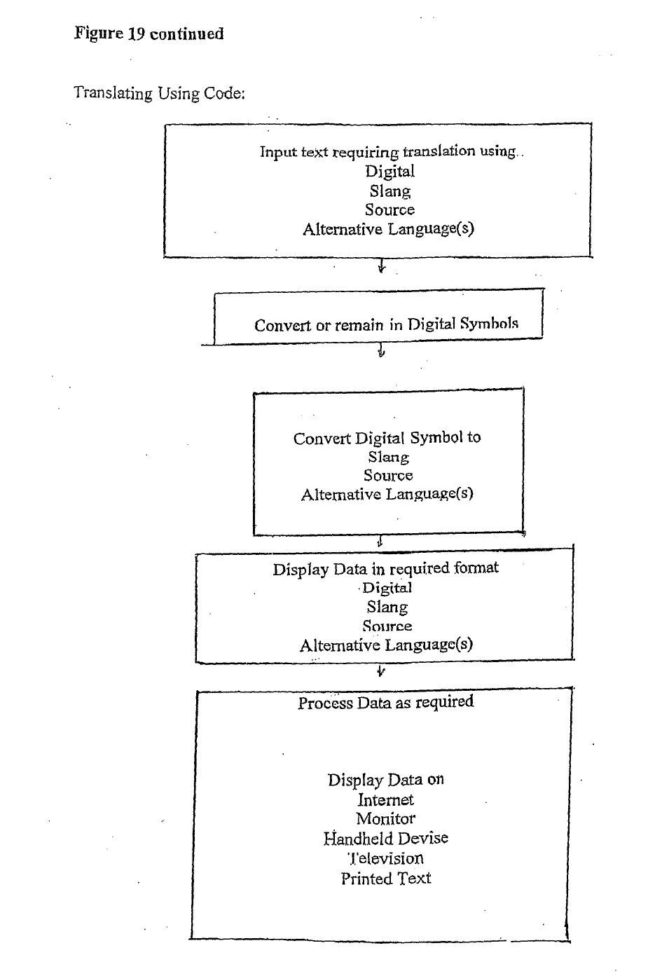

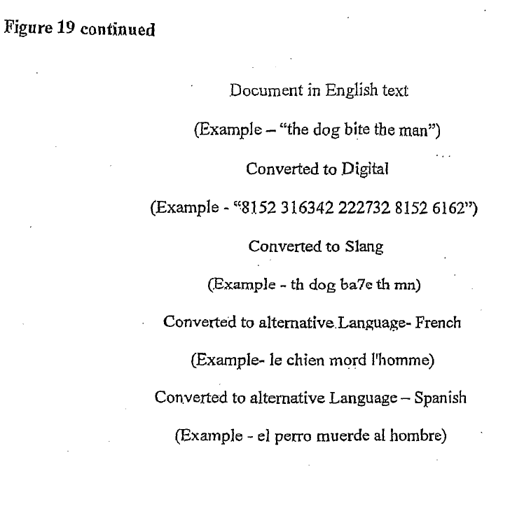

FIG. 19 shows a document in English Text being Displayed and Translated into Code. An Example of a translation of English text converted to Digital, Slang, French and Spanish is given. Since the learning of any new communication system is based on part on the amount of written material available and the variety of the written material being able to encode English creates-a ready made body of material for immediate use and learning purposes.

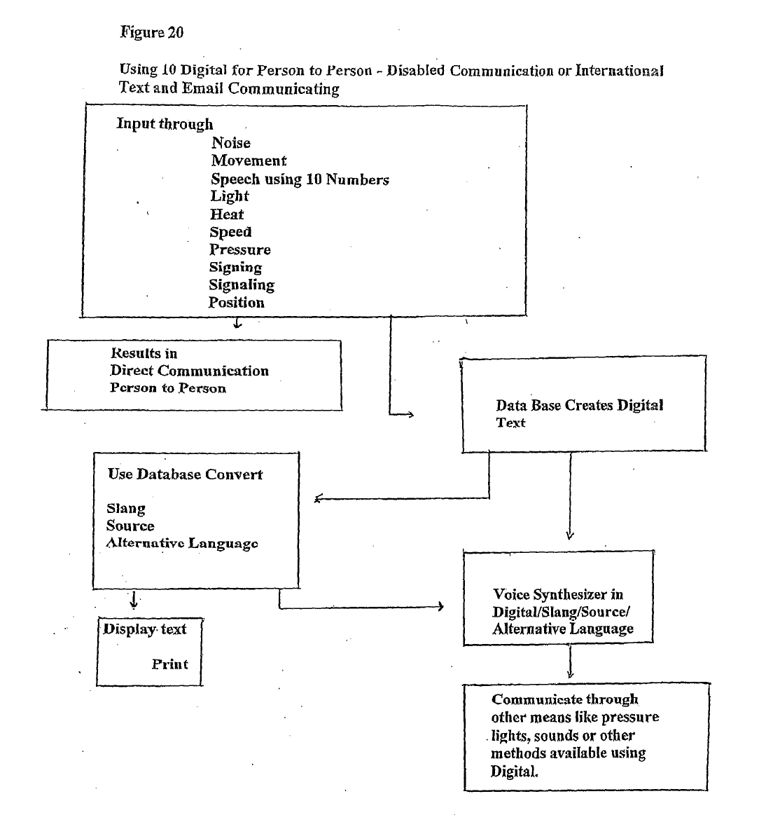

FIG. 20 shows how a person can communicate using noise, movement, speech using 10 numbers, light, heat, speed, pressure, signing, signalling or position. A profoundly disabled person can communicate using the Code if they can make only one sound or one movement. Communication over long distances is possible using light and sound. Since the Code is Digital this allows for method of communicating that are not available in Historic Languages and allows for communication of the profoundly disabled if they can make any movement or noise of any type. The Code also allows people to communicate through pressure using pressure pads or gloves with sensors attached which give digital signals.

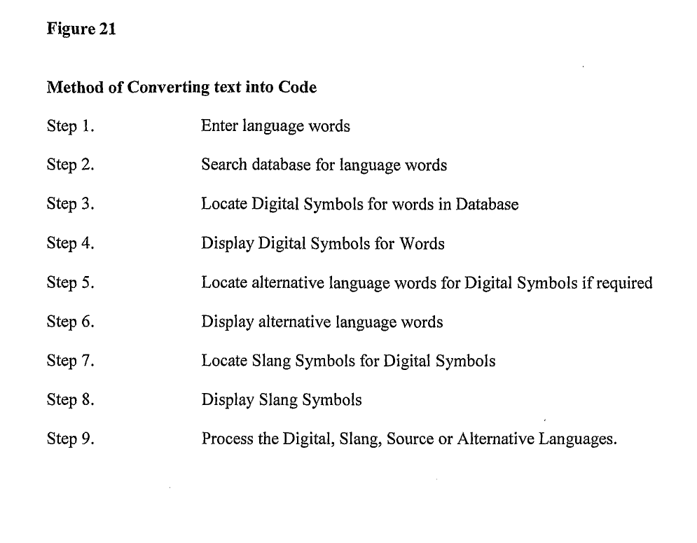

FIG. 21 shows how an English Source text document is processed to create a bases for the Code to be learned and to create a source of written material which will allow the Code to flourish and to be learned easier. Any current English language book can be converted to Code creating a source of material to support the Code for easy of learning.

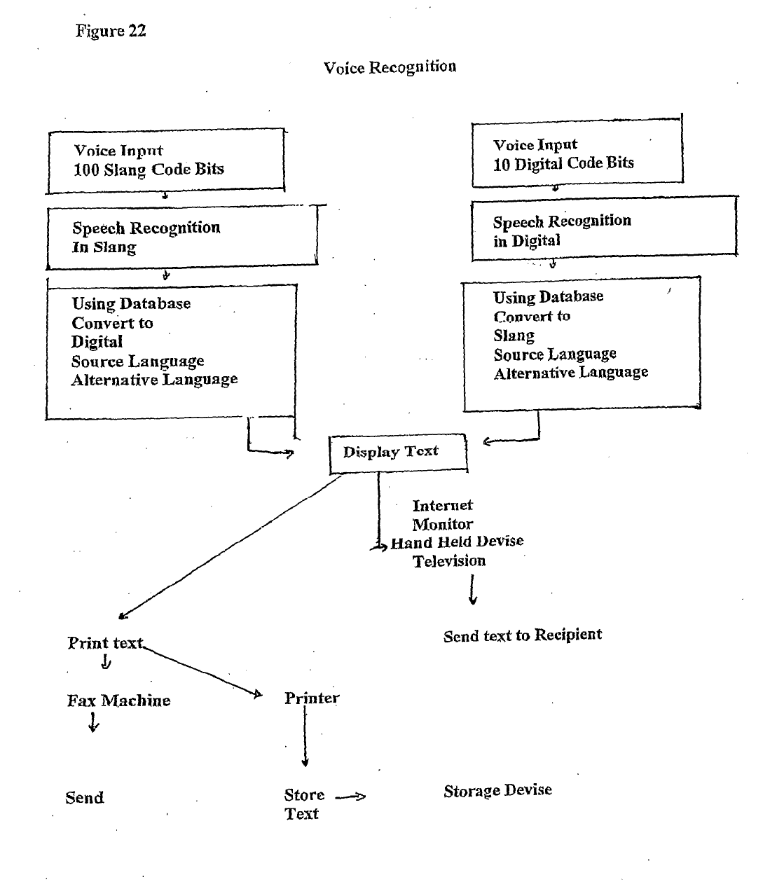

FIG. 22 shows Voice Synthesizer using 10 digits or 100 Code bits is used to create voice recognition software that only requires the identification of 10 short sounds or in full 100 sounds. People are able to speak rather than hand entering their text messages or for the dictation of documents. It is possible for a person to grunt type any message using the Code if the person can not talk.

FIG. 23 shows an example of a 10 Digital Handheld Data Entry Keypad. The Code can be completely inputted and communication carried out by using just the ten numbers. This allows for communication in that each symbol in the Code multi tasks in that it is both a Slang Symbol and Digital Symbol at the same time. Using the pattern set out in the Matrix either of these two uses can be interchanged at will.

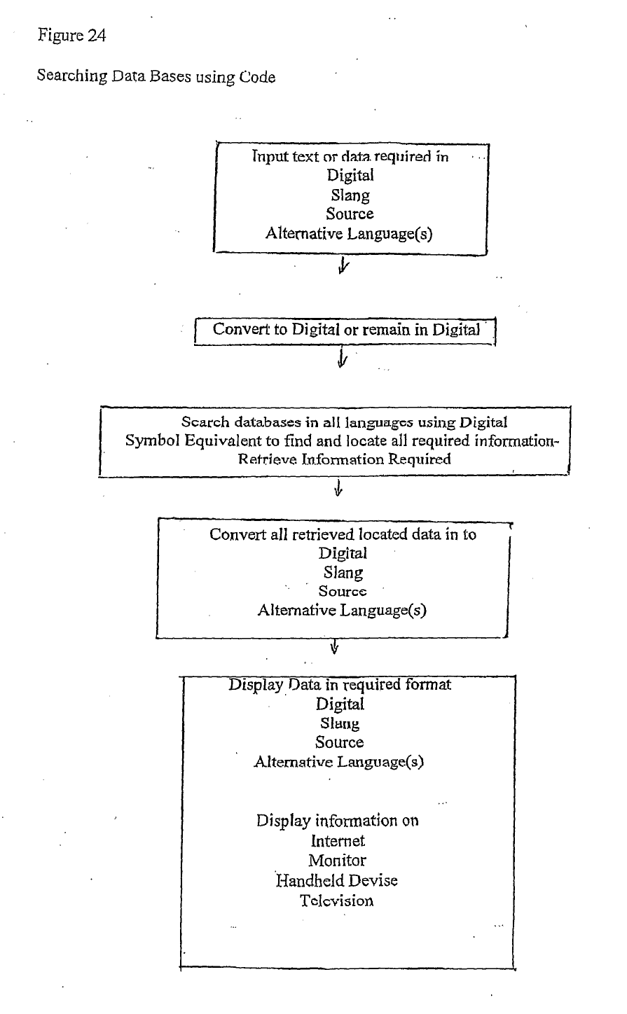

FIG. 24 shows how existing databases are searched using the Code and information retrieved for Display in Digital, Slang, Source or Alternative Languages. Since all language words are ultimately numbers then all words can be digitally searched using the Code. This allows for searching many different data bases in many languages.

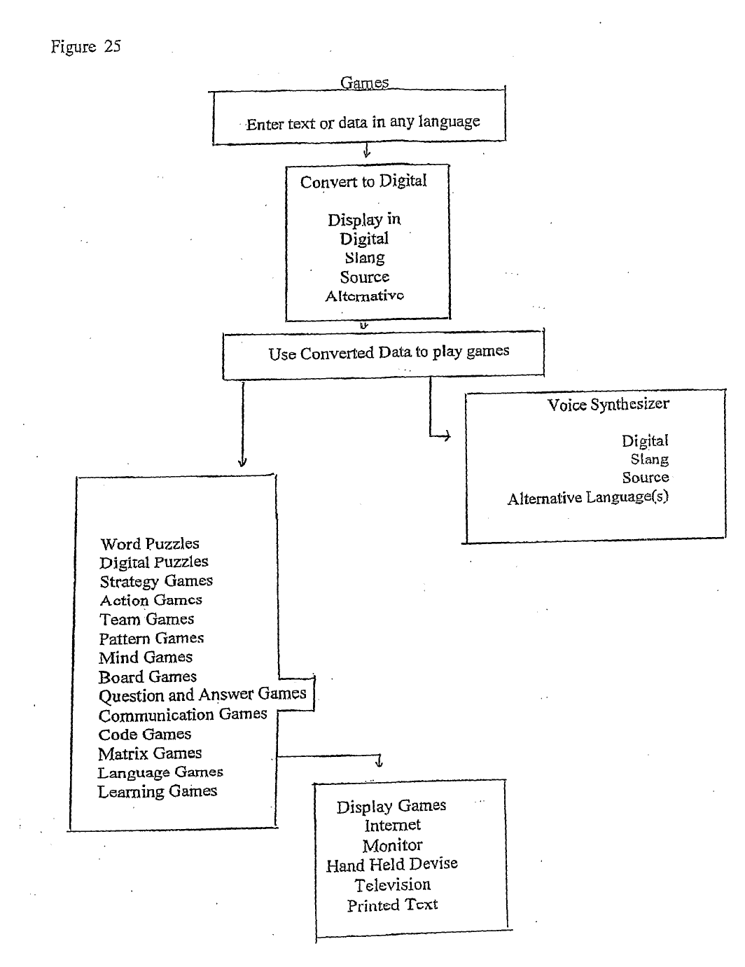

FIG. 25 shows how the Code is used and displayed in Games. Using 10 digit input or Slang input allows individuals without a common language to partake in game playing which would not be possible without the Code. Players can communicate using just the Digital/Slang part of the Code and this allows a universal method of communicating for all game playing activities.

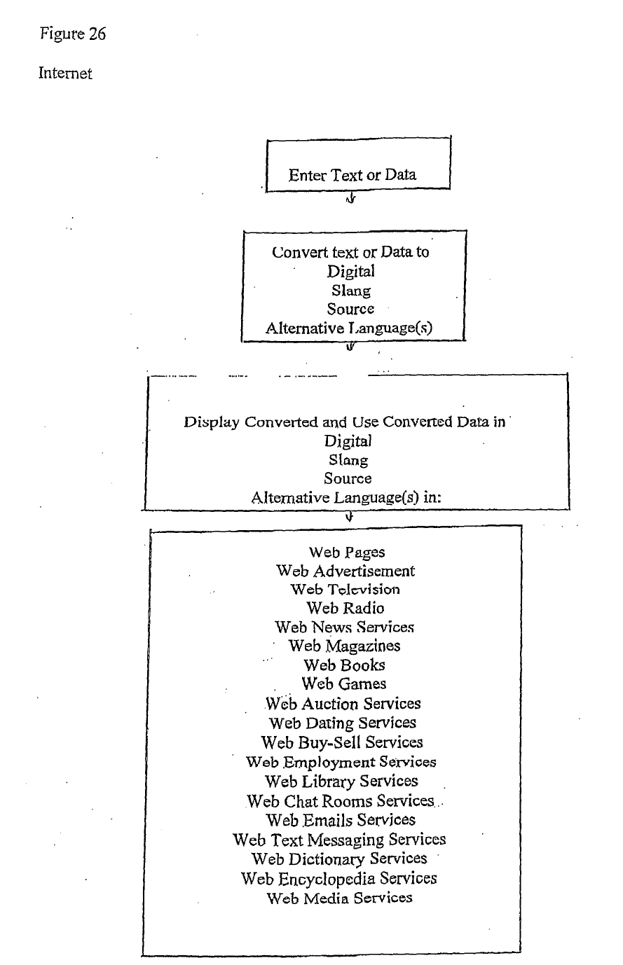

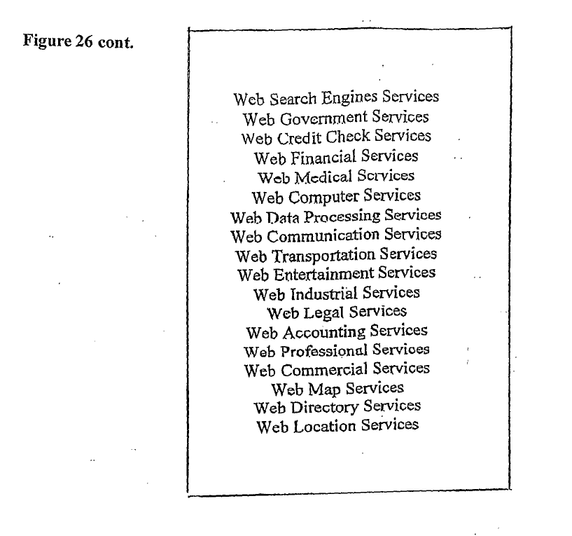

FIG. 26 shows how the Code is used and displayed on the Internet. The internet suffers from not being able to display itself in a form of communication that is universal. The next major break through in world development will have to take place in the field of language communication. The Code allows people to communicate with much less effort than learning a second language which is estimated to take about 12,000 hours. It is estimated that an individual will be able to learn the approximate 900 core symbols in 50 hours by learning and remembering 20 symbols per hour or 3 minutes for each symbol. This will allow for universal communication in chat rooms, by text message and by emails which is not possible now due to the current cross language barriers. People will be able to learn one Code rather than trying to master numerous alternative languages.

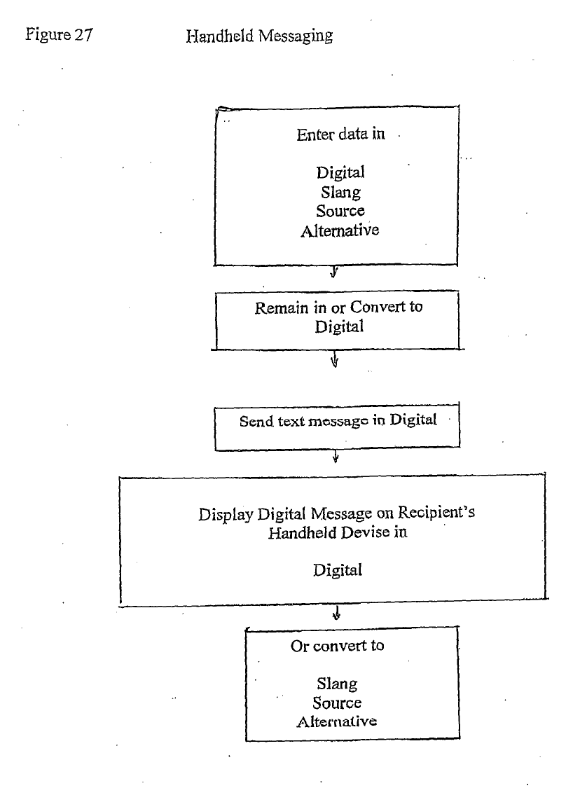

FIG. 27 shows the how handheld text messaging is done using the Code. The underlying bases of the Code is Digital so all text messages can be entered and communicated using just 10 numbers. This allows for messages to be entered in by voice as the Code is a simple repeating pattern and all symbols used in the code are expressed in 10 digits or 100 code parts. Once the message is entered either in Digital format or in Slang format it can be convert to alternative languages if needed to aid in communication. A picture dictionary is used in conjunction with hand held devises to explain unknown symbols. An individual can enter a message in alternative languages which is converted to Digital by the software database stored in the handheld electronic devise.

1. A method of encoding language data in a computer system, including:
receiving input of language data containing words in a text format,
selecting at least some of the words in the language data,
assigning digital codes to the selected words for use when transmitting the words through the keypad of a mobile phone device,
assigning alphanumeric codes to the selected words for use when displaying the words in written form,
assigning pronounceable elements to the digital codes, and
generating an output containing the digital codes and/or the alphanumeric codes, and/or the pronounceable elements.

2. A method of encoding a language for international communication, including:
assigning digital codes to selected words in the language, assigning alphanumeric codes to the digital codes, assigning pronounceable elements to the alphanumeric codes, and
providing instruction on how to use the codes and pronounceable elements for communication.

3. A method according to claim 2 wherein the selected language words include a set of core words required for relatively simple communication in the Code.

4. A method according to claim 2 wherein the selected language words include a set of substantially all words required for communication in the Code.

5. A method according to claim 2 wherein each digital code includes one or more number pairs determined by a two dimensional matrix (1, 2, 3, 4, 5, 6, 7, 8, 9, 0)×(1, 2, 3, 4, 5, 6, 7, 8, 9, 0).

6. A method according to claim 2 wherein most or all of the alphanumeric codes are derived from the digital codes according to the keypad of a mobile phone.

7. A method according to claim 6 wherein the alphanumeric codes include 5 alphabet letters, 46 first letter-number combinations and 28 number-number combinations.

8. A method according to claim 7 wherein the digital code for each alphabet letter item is determined by combining a first digit indicating location of the item on a key of the keypad, with a second digit indicating location of the item in relation to other items on the key.

9. A method according to claim 7 wherein the digital code for each first letter-number item is determined by substituting a first digit of the Code with the first alphabet item from a corresponding key on the keypad and adding a number from 4 to 9.

10. A method according to claim 7 wherein the Number-Number item is the respective two numbered pair from the matrix.

11. A method according to claim 2 wherein the pronounceable elements are derived from small sounds assigned to each of the digits (1, 2, 3, 4, 5, 6, 7, 8, 9, 0).

12. An electronic communication system that encodes words of a language according to claim 1.

13. An electronic communication database system that encodes words of a language that are used in game playing according to claim 1.

14. An electronic communication database system that encodes words of a language that are used to display data on the internet according to claim 1.

15. An electronic communication database system that encodes words of a language that are used to translate languages from one to another according to claim 1.

16. An electronic communication database system that encodes words of a language that are used for voice recognition according to claim 1.

17. An electronic communication database system that encodes words of a language that are used for printed text according to claim 1.

18. An electronic communication database system that encodes words of a language that are used for storing data according to claim 1.

19. An electronic communication database system that encodes words of a language that are used in music, radio or television according to claim 1.

20. An electronic communication database system that encodes words of a language that are used for disabled communication claim 1.

21. An electronic communication database system that encodes words of a language that are used in handheld communication devices according to claim 1.

22. An electronic communication database system that encodes words of a language that are used for voice synthesizing according to claim 1.
